(19) United States
(12) Patent Application Publication
(10) Pub. No.: US 2008/0309923 A1
(43) Pub. Date: Dec. 18, 2008

(54) COMPACT CHEMICAL SENSOR

(76) Inventor: R. Aaron Falk, Renton, WA (US)

Correspondence Address: BLACK LOWE & GRAHAM, PLLC, 701 FIFTH AVENUE, SUITE 4800, SEATTLE, WA, 98104, US

(21) Appl. No.: 12/139,259

(22) Filed: Jun. 13, 2008

Related U.S. Application Data
(60) Provisional application No. 60/944,035, filed on Jun. 14, 2007.

(51) Int. Cl. G01N 21/00

(52) U.S. Cl. 356/73

(57) ABSTRACT

A differential calorimeter device for detection of one or more predefined chemicals. An example device includes an integrating device having an absorbing layer. Optical sources send beams of differing color light at the absorbing layer. An optical detector detects intensity of light reflected off of the absorbing layer and a processor detects presence of the predefined chemicals based on the detected intensity of light associated with the optical sources. The absorbing layer changes color in response to one of said one or more predefined chemicals. One of the optical sources has a color corresponding to the color change in the absorbing layer and another one of the optical sources does not have a color corresponding to the color change in the absorbing layer.

### PRIORITY CLAIM

This application claims the benefit of U.S. Provisional Application Ser. No. 60/944,035 filed Jun. 14, 2007, the contents of which are hereby incorporated by reference.

### FIELD OF THE INVENTION

This invention is directed towards detection of various organic and non-organic chemicals primarily as gasses, liquids, or dilutes.

### BACKGROUND OF THE INVENTION

There are a number of chemical reactions that cause color changes or shifts in a detecting chemical (reagent) when one or more detected chemicals or biological agents are added. This process is often referred to as colorimetry. For example, phenolphthalein is used in detecting the acidity of a solution. The color constituents of many fruits, e.g. bananas and strawberries, change color in the presence of ethylene. The color shift is often detected by eye, which produces limited accuracy and errors. For example a ripe banana is seen by the eye as yellow, but is actually the addition of red coloration to the green background color. In addition, the eye is unable to see color changes that occur in the infrared or ultraviolet, which limits the available agent-reagent combinations.

A single color source and optical detector combination could be used to produce more accurate sensing (see U.S. Pat. No. 4,913,881). However, this approach suffers from requiring a source intensity, an optical transmission, and a detectivity that does not vary with time. That is to say, absolute colorimetry is needed.

A broadband (white light) optical source has been used in combination with color filters followed by detection of the filtered optical components to detect color changes. The source spectrum and filter spectral response will shift (degrade) in time. For this approach to work, changes in the source spectrum and filters must be calibrated. Inexpensive filters are generally broadband with overlapping spectral content. Color standards are needed to calibrate with broadband filters. As with the eye response, this arrangement can produce ambiguous results. For example, the eye sees both the combination of red and green and a pure spectral yellow color as yellow. Narrow banded filters can remove this ambiguity, however narrow band filters are expensive. This approach demands absolute colorimetry.

Spectroscopic devices, e.g. a grating spectrometer, have been used to accurately determine the degree of color change that occurs in an agent-reagent reaction. However, this approach is complex, bulky and expensive. This approach also demands absolute colorimetry.

Thus, there exists a need to produce a compact, simple chemical sensor based on color changes when a detected chemical is present. There is a further need to produce a chemical sensor that is both inexpensive and environmentally robust.

### SUMMARY OF THE INVENTION

The present invention provides a differential calorimeter device for detection of one or more predefined chemicals. An example device includes an integrating device having an absorbing layer, a plurality of optical sources that send beams of differing color light at the absorbing layer, an optical detector that detects intensity of light reflected off of the absorbing layer, and a processor that detects presence of the one or more predefined chemicals based on the detected intensity of light associated with two or more optical sources. The absorbing layer changes color in response to one of said one or more predefined chemicals. One of the optical sources has a color corresponding to the color change in the absorbing layer and another one of the optical sources does not have a color corresponding to the color change in the absorbing layer.

In one aspect of the invention, the processor determines a ratio of intensity of light associated with two optical sources and generates a determination that the one of the predefined chemicals is present, if the determined ratio is outside of a threshold amount. An output device presents presence of the one or more predefined chemicals, if the determination was generated.

In another aspect of the invention, the optical sources include light emitting diodes.

In still another aspect of the invention, the integrating device includes a sphere.

In still another aspect of the invention, the integrating device includes a membrane(s) located adjacent to the absorbing layer opposite a side of the absorbing layer that reflects the light. The membrane is permeable to one of the predefined chemicals.

This sensor can be used as a ‘single use’ device in environmentally unfriendly situations, such as shipping. The present invention avoids the need for absolute radiometry by using a two-color, differential colorimetry approach. Data logging of the color changes allows extraction of detected dose versus time.

### BRIEF DESCRIPTION OF THE DRAWINGS

Preferred and alternative embodiments of the present invention are described in detail below with reference to the following drawings:

FIGS. 1-3 are schematic diagrams showing various embodiments formed in accordance with the present invention.

### DETAILED DESCRIPTION OF THE INVENTION

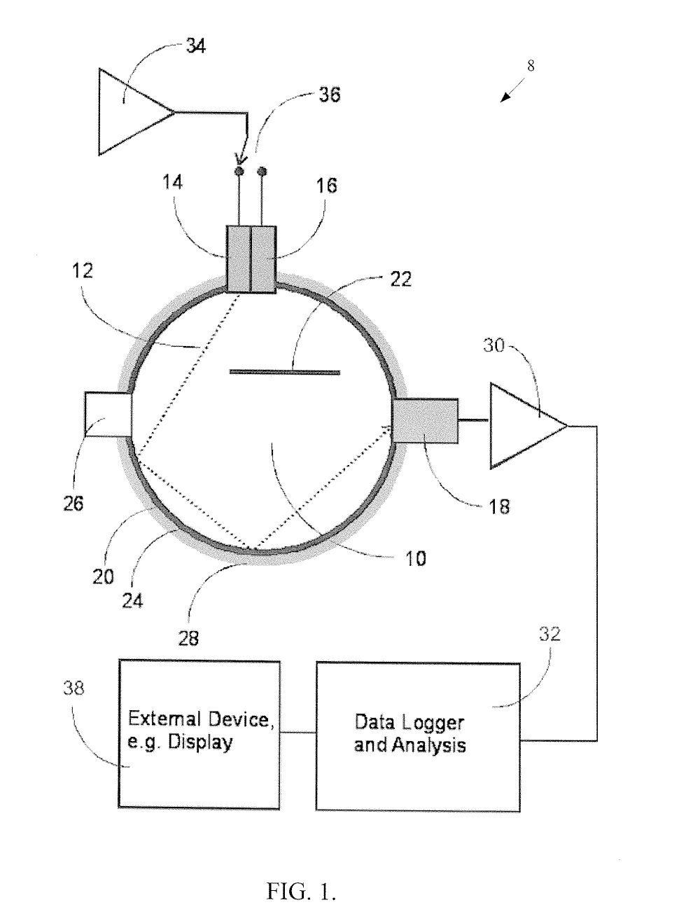

A first configuration of the compact chemical sensor 8 is shown in FIG. 1. The configuration begins with an integrating ‘sphere’ 10. The term integrating sphere is used here to indicate an enclosed structure that has the basic optical property of the apparatus known as an integrating sphere, but is not restricted to spherical geometry. The desirable optical property of an integrating sphere 10 is that light from an optical source must be scattered through multiple reflections from an inside surface 20 of the sphere 10 prior to being absorbed by an optical detector 18. An example optical path 12 is shown in the dotted line that connects between a first optical source 14 and the optical detector 18. Multiple reflections enhance the interaction with the inside surface 20, producing an enhanced change in reflected losses with changes in the optical absorption of an absorbing layer 24 placed on the inside surface 20 of the integrating sphere 10.

The integrating sphere 10 also reduces geometric effects, i.e. the exact position/alignment of the optical source 14 and detector 18 is not critical. In addition, the absorbing layer 24 need not be present over the entire inside surface 20 of the integrating sphere 10. Alternatively, the absorbing layer 24 could be on an independent surface 22 placed anywhere within the integrating sphere 10. Although an actual sphere is the most efficient optical configuration, the integrating sphere 10 can be of any geometry, e.g. a rectangular box or a cylinder. The insensitivity of the integration sphere 10 to alignment is a first step in reducing changes in detection response with variations in temperature, mechanical shock, anything that would cause misalignment of an optical system.

The absorbing layer 24 includes a detection chemical or reagent in conjunction with a suitable binder or matrix. For example, the absorbing layer 24 could be comprised of phenolphthalein within a paper matrix. The reagent matrix produces a color change response to one or more detected chemicals that are introduced into the integrating sphere 10. One or more ports 26 can be used to allow the introduction of the detected chemical in gaseous, liquid or dilute form. Alternately, the absorbing layer 24 can be coated onto a permeable membrane 28 which forms all or part of the integrating sphere 10. Membranes that are permeable to specific chemicals can be used to produce additional detected chemical selectivity (some detecting chemicals, e.g. phenolphthalein, are not very selective as to which detected chemicals they respond too).

The chemical sensor 8 utilizes both the first optical source 14 and a second optical source 16. The desirable property of the two optical sources 14 and 16 is that they have a moderately narrow optical spectrum that is highly independent of environment factors (e.g. temperature). Light emitting diodes, LEDs, are such sources. The waveband of an LED is typically around 50 nanometers, consistent with a single spectral color. The center wavelength of an LED is fixed by the admixture of materials from which it is fabricated. LEDs can be fabricated with center wavelengths ranging from the near infrared to the near ultraviolet.

The optical detector 18 detects the optical intensity from light scattered within the integration sphere 10. A solid state detector, such as a PIN diode or phototransistor configuration, is preferred for the optical detector 18 as the relative color response of this type of detector only depends on the material and geometric properties of the detector. Thus, the relative color response does not depend on factors such as temperature and will not change with time. An electronic amplifier 30 is generally required to amplify and condition the signal produced by the optical detector 18. Use of a single optical detector 18 and amplifier 30 maintains the invariance of the relative color response of this configuration.

In the preferred embodiment, a micro-processor 32 is utilized to convert the signal from the amplifier 30 into a digital format, to record the signal at specific times (data logging), to perform data analysis, and to supply an interface to appropriate displays or external devices 38.

The color of the first optical source 14 is chosen to correspond to the specific color change that occurs in the absorbing layer 24, preferably the peak color change. The color of the second optical source 16 is chosen to correspond to a different part of the color change in the reagent matrix (the absorbing layer 24), preferably a color for which the color change is minimal or zero. For example, for phenolphthalein the color change occurs as a reddish coloration, which suggests that the first optical source 14 be red and the second optical source 16 might be green or blue.

The use of two optical sources allows differential color sensing through examination of the ratio of the optical intensity measured by the detector 18 as produced by each optical source. That is to say, the optical intensity is measured when only the first optical source 14 is on and then again when only the second optical source 16 is on. These two data values are recorded by the micro-processor 32 and their ratio produced. Differential changes in the two intensities result in a change in the ratio. Changes common to both optical paths do not change the ratio and are thereby eliminated. This process is referred to as differential colorimetry.

An additional enhancement to differential colorimerty sensing is to maintain the relative intensity of the two optical sources 14 and 16. The intensity of an LED is proportional to the current passing through it. A pair of compensated current sources could be used, one for each LED to supply a fixed intensity. However a simpler approach is to use a common current source 34 and a switch 36 to supply an identical current to both LEDs (the optical sources 14 and 16). The micro-processor 32 is synchronized to the switch 36 to allow acquisition of the optical intensity for each optical source 14 or 16 as described above. This switching process also eliminates slow drifts in the common signal path and reduces noise at frequencies differing from the switching frequency. Additional acquisition of the detector 18 response when both detectors are off, allows removal of any DC offsets and signal enhancements similar to those obtained with lock-in amplifiers.

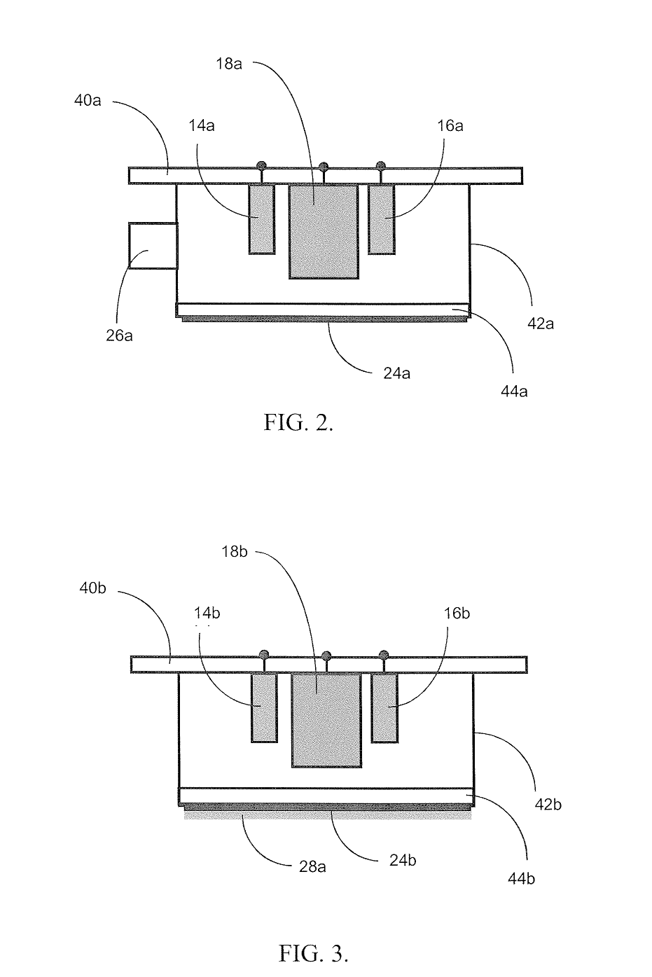

FIGS. 2 and 3 show two practical implementations of the current invention. Common components, the amplifier 30, the microprocessor 32, the current source 34 and the switch 36 and the display or external devices 38 are not shown for simplicity, but are assumed to be present. Printed circuit boards 40a,b are used to mount first optical sources 14a,b, second optical sources 16a,b and optical detectors 18a,b. The printed circuit boards 40a,b are mounted using a standard method of mounting such components. The mounting method is inexpensive and allows connection to and mounting of additional electronic components, e.g. the current source 34. The printed circuit boards 40a,b are attached to cylindrical or rectangular canisters 42a,b. The canisters 42a,b could be metal with highly reflective walls or plastic with diffuse white walls or some combination thereof. The canisters 42a,b can be attached to the circuit boards 40a,b by a variety of mechanical means, e.g. epoxy. In the current configuration the surface of the canisters 42a,b opposite the printed circuit boards 40a,b include an absorbing layer 24a,b, which could be a direct part of the canister or attached to transparent windows 44a,b. Metal canisters with glass windows are a common electro-optic component, therefore inexpensive.

Exposure of the absorbing layers 24a,b can occur by direct contact with the detected chemical. A protective layer can be used to exclude exposure to the absorbing layers 24a,b until the protective layer is removed. FIG. 2 shows a configuration in which the detected chemical is introduced via a port 26a. FIG. 3 shows a configuration in which a permeable membrane 28a is used to allow introduction of the detected chemical.

Additional optical sources beyond two can be added to extend the current invention to detection of multiple different chemicals. Means to remove and attach different absorbing layers would extend this capability.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A differential colorimeter device for detection of one or more predefined chemicals, the device comprising:
an optically integrating device;
an absorbing layer contained within the integrating device, the absorbing layer changes color in response to one of said one or more predefined chemicals;
a plurality of optical sources configured to send beams of differing color light at the absorbing layer, at least one of the optical sources has a color corresponding to the color change in the absorbing layer and another one of the optical sources does not have a color corresponding to the color change in the absorbing layer; and
an optical detector configured to detect intensity of light produced by the optical sources as reflected off of the absorbing layer.

2. The device of claim 1, further comprising:
a processing device configured to detect presence of the one or more predefined chemicals based on the detected intensity of light associated with two or more optical sources, wherein the processing device is further configured to determine a ratio of intensity of light associated with two optical sources.

3. The device of claim 2, wherein the processing device is further configured to generate an indication that the one of the predefined chemicals is present based on the determined ratio.

4. The device of claim 3, further comprising an output device configured to present presence of the one or more predefined chemicals, if the determination was generated.

5. The device of claim 1, wherein the optical sources include light emitting diodes.

6. The device in claim 1, wherein the integrating device includes a sphere.

7. The device of claim 1, wherein the optical detector includes a solid state detector.

8. The device of claim 1, wherein the integrating device includes at least one membrane located adjacent to the absorbing layer opposite a side of the absorbing layer that reflects the light.

9. The device of claim 8, wherein the at least one membrane is permeable to at least one of the predefined chemicals.

10. A method for detecting one or more predefined chemicals, the method comprising:
generating two or more beams of differing color light at an absorbing layer of an optically integrating device;
detecting intensity of the generated light as reflected off of the absorbing layer; and
detecting presence of the one or more predefined chemicals based on the detected intensity of light associated with two or more optical sources.

11. The method of claim 10, wherein the generated two or more beams of differing color light include one beam having a color corresponding to the color change in the absorbing layer and another beam that does not have a color corresponding to the color change in the absorbing layer.

12. The method of claim 10, wherein detecting presence comprises determining a ratio of intensity of light associated with two or more beams.

13. The method of claim 12, wherein detecting presence comprises outputting an indication that the one of the predefined chemicals is present based on the determined ratio.

14. The method of claim 10, wherein the two or more beams are produced by light emitting diodes.

15. The method of claim 10, wherein the integrating device includes a sphere.

16. The method of claim 10, wherein the integrating device includes at least one membrane located adjacent to the absorbing layer opposite a side of the absorbing layer that reflects the light.

17. The method of claim 16, wherein the at least one membrane is permeable to at least one of the defined chemicals.
